(19) United States
(12) Patent Application Publication
(10) Pub. No.: US 2025/0234301 A1
(43) Pub. Date: Jul. 17, 2025

(54) UPLINK POWER CONTROL CONFIGURATION

(71) Applicant: Lenovo (Singapore) Pte. Limited, Singapore (SG)

(72) Inventor: Khaled Nafez Rauf Ardah, Ilmenau (DE)

(73) Assignee: Lenovo (Singapore) Pte. Limited, Singapore (SG)

(21) Appl. No.: 19/020,064

(22) Filed: Jan. 14, 2025

Related U.S. Application Data
(60) Provisional application No. 63/621,671, filed on Jan. 17, 2024.

(51) Int. Cl. H04W 52/14; H04L 5/00; H04L 5/14; H04W 72/0446

(52) U.S. Cl. CPC H04W 52/146; H04L 5/0005; H04L 5/14; H04W 72/0446

(57) ABSTRACT

Various aspects of the present disclosure relate to uplink power control configuration. An apparatus, such as a user equipment (UE), receives a configuration message for uplink power control, the configuration message indicating one or more uplink power control parameter sets each associated with a different time resource type. The UE transmits, based at least in part on the configuration message and according to the one or more uplink power control parameter sets, an uplink transmission using a first uplink transmit power for the uplink transmission during a first time resource type and using a second uplink transmit power during a second time resource type.

### RELATED APPLICATION

This application claims priority to U.S. Provisional Application Ser. No. 63/621,671 filed 17 Jan. 2024 entitled “UPLINK POWER CONTROL CONFIGURATION,” the disclosure of which is incorporated by reference herein in its entirety.

### TECHNICAL FIELD

The present disclosure relates to wireless communications, and more specifically to full-duplex (FD) communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive a configuration message for uplink power control, the configuration message indicating one or more uplink power control parameter sets each associated with a different time resource type; and transmit, based at least in part on the configuration message and according to the one or more uplink power control parameter sets, an uplink transmission using a first uplink transmit power for the uplink transmission during a first time resource type and using a second uplink transmit power during a second time resource type.

In some implementations of the method and apparatuses for a UE described herein, the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and the configuration message implicitly associates at least one uplink power control parameter set to one or more of a time resource index set or a time-resources type; the at least one processor is configured to cause the UE to determine the first uplink transmit power based at least in part on a first uplink power control parameter set and determine the second uplink transmit power based at least in part on a second uplink power control parameter set; the one or more uplink power control parameter sets are each associated with a different time resource index set, and the at least one processor is configured to cause the UE to transmit the uplink transmission according to the first uplink transmit power and the second uplink transmit power and during corresponding time resource indexes.

In some implementations of the method and apparatuses for a UE described herein, the one or more uplink power control parameter sets are each associated with a different time resource index set, and the configuration message explicitly associates an uplink power control parameter set to one or more of an indicated time resource index set or an indicated time resources type; a time-resources type includes a subband full duplex (SBFD) time resource or non-SBFD time resource; the at least one processor is configured to cause the UE to determine one or more of the SBFD time resource or the non-SBFD time resource from an independent time-frequency configuration message; the at least one processor is configured to cause the UE to receive a set-reassociation message indicating a new associated uplink power control parameter set to be used during an indicated time resource index set or an indicated time resource type; the configuration message further includes one or more of self-interference (SI) reference signal (RS) information or SI measurement resources (SI-MRs), or a combination thereof.

In some implementations of the method and apparatuses for a UE described herein, the one or more of the SI RS information or the SI-MRs are associated with one or more of the uplink power control parameter sets; the one or more of the SI RS information or the SI-MRs are associated with one or more time resource indexes set or one or more time resources types; the UE includes a full-duplex capable UE, and the at least one processor is configured to cause the UE to compute, based at least in part on the one or more of SI RS or the SI-MRs, the first uplink transmit power corresponding to a SI value below a predefined value; the at least one processor is configured to cause the UE to determine, based at least in part on an associated power control parameter, the second uplink transmit power; the at least one processor is configured to cause the UE to determine a third uplink transmit power based at least in part on the first uplink transmit power and the second uplink transmit power; the at least one processor is configured to cause the UE to transmit the uplink transmission using the third uplink transmit power during one or more of a corresponding time resource index or a time resource type.

Some implementations of the method and apparatuses described herein may further include a processor for wireless communication to receive a configuration message for uplink power control, the configuration message indicating one or more uplink power control parameter sets each associated with a different time resource type; and transmit, based at least in part on the configuration message and according to the one or more uplink power control parameter sets, an uplink transmission using a first uplink transmit power for the uplink transmission during a first time resource type and using a second uplink transmit power during a second time resource type.

In some implementations of the method and apparatuses for a processor described herein, the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and the configuration message implicitly associates at least one uplink power control parameter set to one or more of a time resource index set or a time-resources type; the at least one controller is configured to cause the processor to determine the first uplink transmit power based at least in part on a first uplink power control parameter set and determine the second uplink transmit power based at least in part on a second uplink power control parameter set; the one or more uplink power control parameter sets are each associated with a different time resource index set, and the at least one controller is configured to cause the processor to transmit the uplink transmission according to the first uplink transmit power and the second uplink transmit power and during corresponding time resource indexes.

In some implementations of the method and apparatuses for a processor described herein, the one or more uplink power control parameter sets are each associated with a different time resource index set, and the configuration message explicitly associates an uplink power control parameter set to one or more of an indicated time resource index set or an indicated time resources type; a time-resources type includes a SBFD time resource or non-SBFD time resource; the at least one controller is configured to cause the processor to determine one or more of the SBFD time resource or the non-SBFD time resource from an independent time-frequency configuration message; the at least one controller is configured to cause the processor to receive a set-reassociation message indicating a new associated uplink power control parameter set to be used during an indicated time resource index set or an indicated time resource type; the configuration message further includes one or more of SI RS information or SI-MRs, or a combination thereof; the one or more of the SI RS information or the SI-MRs are associated with one or more of the uplink power control parameter sets.

In some implementations of the method and apparatuses for a processor described herein, the one or more of the SI RS information or the SI-MRs are associated with one or more time resource indexes set or one or more time resources types for a user equipment (UE); the configuration message is configured for a user equipment (UE), the UE includes a full-duplex capable UE, and the at least one controller is configured to cause the processor to compute, based at least in part on the one or more of SI RS or the SI-MRs, the first uplink transmit power corresponding to a SI value below a predefined value; the at least one controller is configured to cause the processor to determine, based at least in part on an associated power control parameter, the second uplink transmit power; the at least one controller is configured to cause the processor to determine a third uplink transmit power based at least in part on the first uplink transmit power and the second uplink transmit power; the at least one controller is configured to cause the processor to transmit the uplink transmission using the third uplink transmit power during one or more of a corresponding time resource index or a time resource type.

Some implementations of the method and apparatuses described herein may further include a method performed by a UE, the method including receiving a configuration message for uplink power control, the configuration message indicating one or more uplink power control parameter sets each associated with a different time resource type; and transmitting, based at least in part on the configuration message and according to the one or more uplink power control parameter sets, an uplink transmission using a first uplink transmit power for the uplink transmission during a first time resource type and using a second uplink transmit power during a second time resource type.

In some implementations of the method and apparatuses described herein, the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and the configuration message implicitly associates at least one uplink power control parameter set to one or more of a time resource index set or a time-resources type; determining the first uplink transmit power based at least in part on a first uplink power control parameter set and determine the second uplink transmit power based at least in part on a second uplink power control parameter set.

In some implementations of the method and apparatuses described herein, the one or more uplink power control parameter sets are each associated with a different time resource index set, and the method further includes transmitting the uplink transmission according to the first uplink transmit power and the second uplink transmit power and during corresponding time resource indexes; the one or more uplink power control parameter sets are each associated with a different time resource index set, and the configuration message explicitly associates an uplink power control parameter set to one or more of an indicated time resource index set or an indicated time resources type; a time-resources type includes a SBFD time resource or non-SBFD time resource; determining one or more of the SBFD time resource or the non-SBFD time resource from an independent time-frequency configuration message; receiving a set-reassociation message indicating a new associated uplink power control parameter set to be used during an indicated time resource index set or an indicated time resource type.

In some implementations of the method and apparatuses described herein, the configuration message further includes one or more of SI RS information or SI-MRs, or a combination thereof; the one or more of the SI RS information or the SI-MRs are associated with one or more of the uplink power control parameter sets; the one or more of the SI RS information or the SI-MRs are associated with one or more time resource indexes set or one or more time resources types; the UE includes a full-duplex capable UE, and the method further includes computing, based at least in part on the one or more of SI RS or the SI-MRs, the first uplink transmit power corresponding to a SI value below a predefined value; determining, based at least in part on an associated power control parameter, the second uplink transmit power; determining a third uplink transmit power based at least in part on the first uplink transmit power and the second uplink transmit power; transmitting the uplink transmission using the third uplink transmit power during one or more of a corresponding time resource index or a time resource type.

Some implementations of the method and apparatuses described herein may further include a network equipment (NE) for wireless communication to transmit, to a user equipment (UE), a configuration message for uplink power control, the configuration message indicating one or more uplink power control parameter sets each associated with a different time resource type; and receive, from the UE, an uplink transmission.

In some implementations of the method and apparatuses described herein, the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and the configuration message implicitly associates at least one uplink power control parameter set to one or more of a time resource index set or a time-resources type; the one or more uplink power control parameter sets are each associated with a different time resource index set, and the configuration message explicitly associates an uplink power control parameter set to one or more of an indicated time resource index set or an indicated time resources type.

In some implementations of the method and apparatuses described herein, a time-resources type includes a SBFD time resource or non-SBFD time resource; the at least one processor is configured to cause the network equipment to transmit a set-reassociation message indicating a new associated uplink power control parameter set to be used during an indicated time resource index set or an indicated time resource type; the configuration message further includes one or more of SI RS information or SI measurement resources (MRs), or a combination thereof; the one or more of the SI RS information or the SI-MRs are associated with one or more of the uplink power control parameter sets; the one or more of the SI RS information or the SI-MRs are associated with one or more time resource indexes set or one or more time resources types.

Some implementations of the method and apparatuses described herein may further include a method performed by a NE, the method including transmitting, to a user equipment (UE), a configuration message for uplink power control, the configuration message indicating one or more uplink power control parameter sets each associated with a different time resource type; and receiving, from the UE, an uplink transmission.

In some implementations of the method and apparatuses described herein, the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and the configuration message implicitly associates at least one uplink power control parameter set to one or more of a time resource index set or a time-resources type; the one or more uplink power control parameter sets are each associated with a different time resource index set, and the configuration message explicitly associates an uplink power control parameter set to one or more of an indicated time resource index set or an indicated time resources type.

In some implementations of the method and apparatuses described herein, a time-resources type includes a SBFD time resource or non-SBFD time resource; transmitting a set-reassociation message indicating a new associated uplink power control parameter set to be used during an indicated time resource index set or an indicated time resource type; the configuration message further includes one or more of SI RS information or SI measurement resources (MRs), or a combination thereof; the one or more of the SI RS information or the SI-MRs are associated with one or more of the uplink power control parameter sets; the one or more of the SI RS information or the SI-MRs are associated with one or more time resource indexes set or one or more time resources types.

### BRIEF DESCRIPTION OF THE DRAWINGS

FIG. 1 illustrates an example of a wireless communications system in accordance with aspects of the present disclosure.

FIG. 2 illustrates a scenario 200 for wireless communications.

FIG. 3 illustrates a scenario 300 for wireless communications.

FIG. 4 illustrates an example scenario 400 in accordance with aspects of the present disclosure.

FIG. 5 illustrates an example signaling diagram 500 in accordance with aspects of the present disclosure.

FIG. 6 illustrates an example scenario 600 in accordance with aspects of the present disclosure.

FIG. 7 illustrates an example signaling diagram 700 in accordance with aspects of the present disclosure.

FIG. 8 and FIG. 9 illustrate example scenarios 800 and 900 in accordance with aspects of the present disclosure.

FIG. 10 illustrates an example of a UE 1000 in accordance with aspects of the present disclosure.

FIG. 11 illustrates an example of a processor 1100 in accordance with aspects of the present disclosure.

FIG. 12 illustrates an example of a NE 1200 in accordance with aspects of the present disclosure.

FIG. 13 illustrates a flowchart of a method 1300 in accordance with aspects of the present disclosure.

FIG. 14 illustrates a flowchart of a method 1400 in accordance with aspects of the present disclosure.

### DETAILED DESCRIPTION

Wireless communications systems can utilize duplexing modes for transmitting and receiving data, such as at a UE. For instance, time division duplex (TDD) and frequency division duplex (FDD) are two duplexing modes used by some current wireless networks. TDD uses a same carrier frequency and splits the time resources between the downlink (DL) and uplink (UL) communications. FDD enables simultaneous UL and DL communications and using different carrier frequencies. Further, full duplex (FD) mode enables simultaneous UL and DL communications over the same carrier frequency and same time resource. FD mode can enable gains and enhancements in terms of increasing the system capacity and coverage and/or reducing latency, such as compared to the half-duplex TDD and FDD modes. However, when using the same time and frequency resources for UL and DL communication such as in FD mode, SI and cross link interference (CLI) issues can arise which can reduce signal quality and increase signal latency.

Accordingly, aspects of the disclosure are directed to supporting UL and DL quality of service (QoS) targets in FD modes using efficient UL power control selection and adaptation such as in accordance with CLI and SI level changes at both UEs and serving gNBs. For instance, in implementations a UE receives, from its serving network node (e.g., a serving gNB), a configuration message containing one or more power control parameter sets to be used for determining the UL power (e.g., for a Physical Uplink Shared Channel (PUSCH), Physical Uplink Control Channel (PUCCH), Sounding Reference Signals (SRS), and a Physical Random Access Channel (PRACH) transmission) for a plurality of time resource (e.g., symbols and/or slots) sets. The power control parameter sets contain, at least, one different parameter value, e.g., different open-loop parameters and/or different fractional pathloss compensation factor. In at least some implementations, the configuration message explicitly configures each power control parameter set. Alternatively or additionally the configuration message explicitly configures a first power control parameter set and the offset value of one or more parameters to be used when determining the one or more of second power control parameter sets. The UE can utilize the power control parameter sets for transmitting uplink transmissions.

By utilizing the described techniques, QoS goals in data transmission and data reception can be achieved such as by reducing CLI and SI at both UEs and serving cells, e.g., serving gNBs.

Aspects of the present disclosure are described in the context of a wireless communications system.

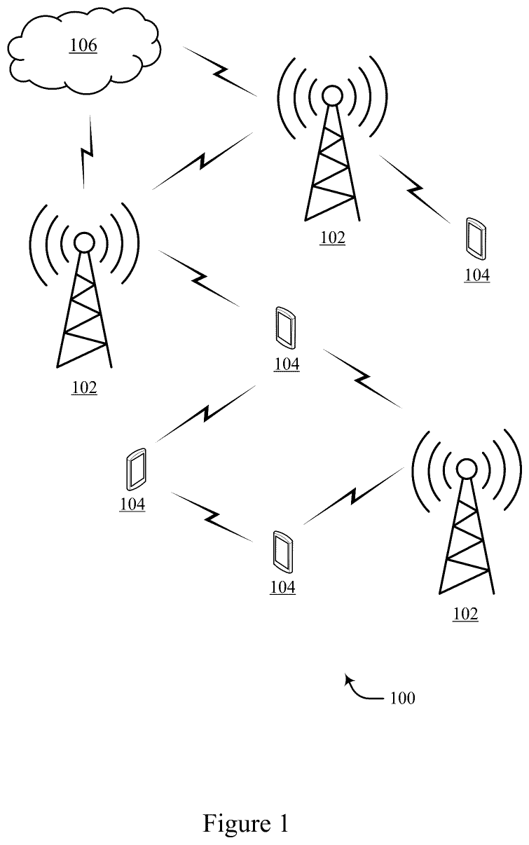

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives, from a NE 102, a configuration message for uplink power control, where the configuration message indicates one or more uplink power control parameter sets each associated with a different time resource type. The UE 104 then transmits, based at least in part on the configuration message and according to the one or more uplink power control parameter sets, an uplink transmission using a first uplink transmit power for the uplink transmission during a first time resource type and using a second uplink transmit power during a second time resource type.

With reference to transmission in wireless communications systems, TDD and FDD are two duplexing modes used by current wireless networks. TDD uses the same carrier frequency but splits the time resources between the DL and uplink (UL) communications. FDD enables simultaneous UL and DL communications, but using different carrier frequencies. Full duplex (FD) mode enables simultaneous UL and DL communications over the same carrier frequency and same time resource.

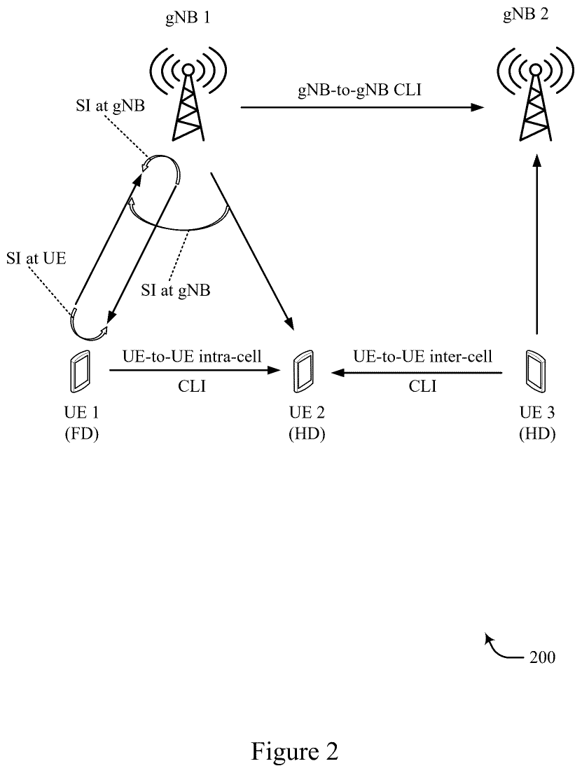

FIG. 2 illustrates a scenario 200 for wireless communications. The scenario 200, for instance illustrates that CLI and SI can occur in a FD mode. In a FD mode, using the same time and frequency resources for UL and DL communications, (e.g., as in FD mode) can cause SI and CLI issues as illustrated in the scenario 200, which are defined as follows. Self-interference (SI): where the transmitted DL/UL signal by a network node (e.g., gNB or UE) leaks energy onto its received UL/DL signal. Cross-link interference (CLI): where the transmitted DL/UL signal by a network node (e.g., gNB or UE) leaks energy onto received UL/DL signal of a nearby node.

To optimize usage of the FD mode, SI and CLI are to be properly managed. One solution to the SI and CLI issues is to split the frequency resources of a time resource into non-overlapping DL and UL subbands (SBs), where each subband includes one or more resource-blocks (RBs). Such an approach can reduce the impact of SI and CLI and has been introduced as a study item within 3GPP Rel-18 and called non-overlapping SBFD. Other solutions to handle SI and CLI include the use of different antenna panels for DL and UL communications, coordination for scheduling spatial domain, advance receivers, beam nulling, and UL and DL power control (PC).

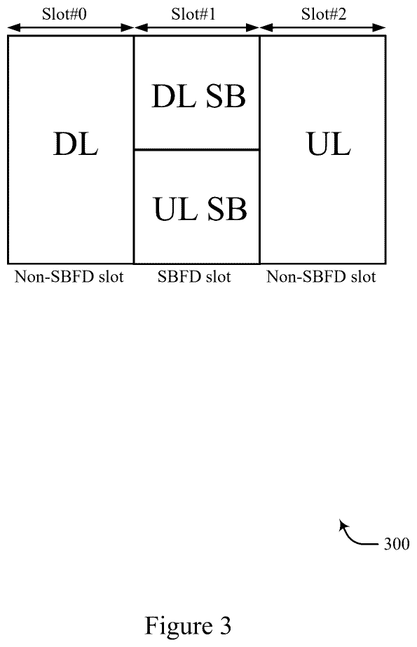

FIG. 3 illustrates a scenario 300 for wireless communications. The scenario 300, for instance, illustrates time slot resources splitting between SBFD-based and non-SBFD-based slots. In time domain, some of the time resources (e.g., symbols or slots) may be used for SBFD communications, while others can be used for half-duplex (HD) DL or UL communications, such as illustrated in the scenario 300. Such time resources-based division is beneficial in some scenarios, e.g., to protect some DL or UL signals/channels from the impacts of SI and/or CLI. For example, in the scenarios where the resource scheduler (e.g., the gNB) is expecting high SI and/or CLI levels, the gNB may schedule the high-priority UL signals on a non-SBFD slot (e.g., slot #2 in the scenario 300), and schedule low-priority UL signals on the UL subband (SB) of a SBFD slot (e.g., slot #1 in the scenario 300).

For instance, in such scenarios, the expected signal-to-interference and noise ratio (SINR) at the receiver of the gNB is likely to be very low due to the anticipated high SI and/or CLI levels. However, in some other scenarios, the gNB may schedule the high-priority UL signals on the UL SB of a SBFD slot, as it may anticipate low SI and/or CLI levels. For example, the gNB may decide to use a highly efficient SI and/or CLI managing technique on one or more SBFD slots. The target gNB, for instance, can use an advance receiver technique and/or the nearby gNBs use a beam nulling transmit precoding technique. In such cases, the gNB may expect low SI and/or CLI levels, allowing the high-priority UL signals/channels to be scheduled on these SBFD slots. Such an operation may benefit from better UL transmission parameters scheduling, configuration, and selection.

In wireless communications systems, uplink power control can determine a power for PUSCH, PUCCH, SRS, and PRACH transmissions. For instance, if a UE transmits a PUSCH on active UL bandwidth part (BWP) b of carrier f of serving cell c using parameter set configuration with index j and PUSCH power control adjustment state with index l, the UE can determine the PUSCH transmission power P_{PUScH,b,f,c}(i,j,q_{d},l) in dBm in PUSCH transmission occasion i as

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

If a UE transmits a PUCCH on active UL BWP b of carrier f in the primary cell c using PUCCH power control adjustment state with index l, the UE determines the PUCCH transmission power P_{PUCCH,b,f,c}(i,qᵤ,q_{d},l) in dBm in PUCCH transmission occasion i as

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \}$$

If a UE transmits SRS based on a configuration by SRS-ResourceSet on active UL BWP b of carrier f of serving cell c using SRS power control adjustment state with index l, the UE determines the SRS transmission power P_{SRS,b,f,c}(i,qₛ,l) in dBm in SRS transmission occasion i as

$${P}_{SRS , b , f , c} ( i , {q}_{s} , l ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix} \}$$

Example definitions for the parameters described above can be found in section 7 of 3GPP Technical Specification (TS) 38.213 (V18.0.0).

Accordingly, in aspects of this disclosure, techniques are disclosed to enable meeting UL and DL QoS (quality of service) targets by efficient UL power control selection and adaptation in accordance to CLI and SI levels change at both UE and serving gNB.

In implementations a UE receives, from its serving network node (e.g., a serving gNB), a configuration message containing one or more power control parameter sets to be used for determining the UL power (e.g., for a PUSCH, PUCCH, SRS, and a PRACH transmission) for a plurality of time resource (e.g., symbols and/or slots) sets. The power control parameter sets contain, at least, one different parameter value, e.g., different open-loop parameters and/or different fractional pathloss compensation factor. In some implementations, the configuration message explicitly configures each power control parameter set. In some other implementations, the configuration message explicitly configures a first power control parameter set and the offset value of one or more parameters to be used when determining the one or more of second power control parameter sets.

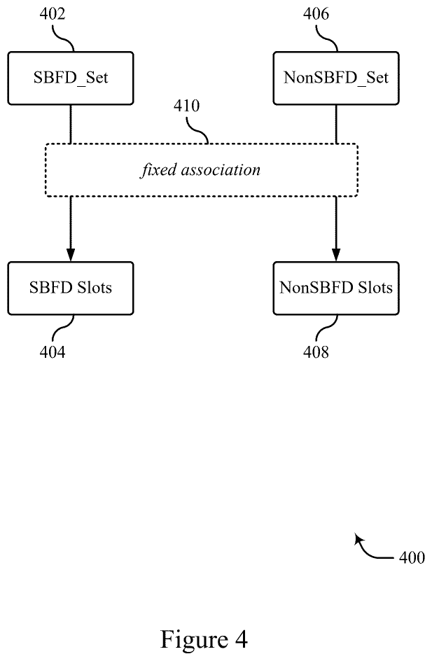

FIG. 4 illustrates an example scenario 400 in accordance with aspects of the present disclosure. The scenario 400, for instance, illustrates fixed association between power control sets and slot types. The scenario 400 includes a power control parameter SBFD_Set 402, SBFD slots 404, a power control parameter NonSBFD_set 406, and non-SBFD slots 408. Further, a fixed association 410 is illustrated between the SBFD_Set 402 and the NonSBFD_set 406.

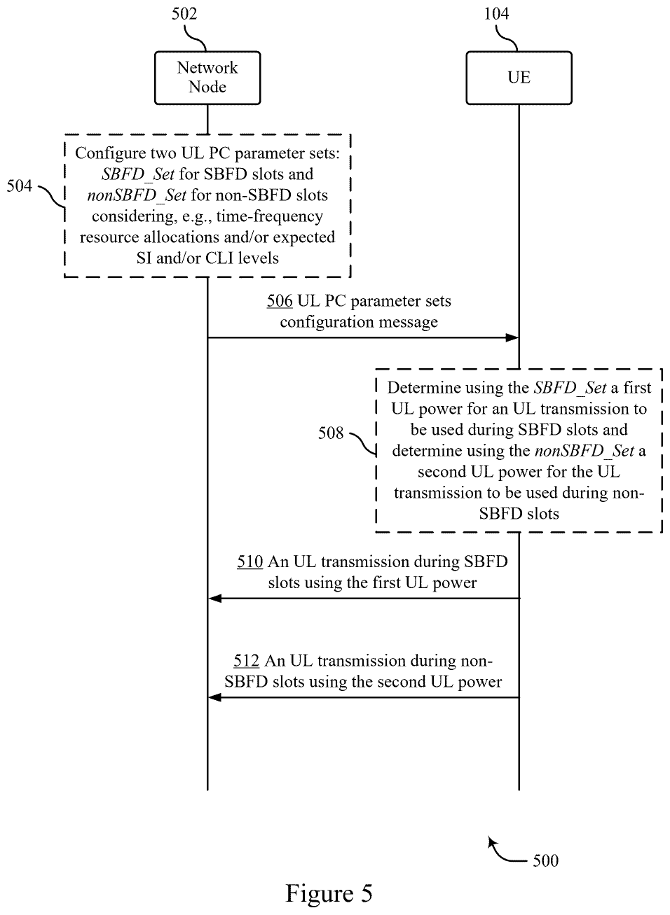

FIG. 5 illustrates an example signaling diagram 500 in accordance with aspects of the present disclosure. The signaling diagram includes a network node 502 (e.g., an NE 102 such as a gNB) and a UE 104, operations of the network node 502 and the UE 104, signaling by the network node 502, and data transmission by the UE 104. In the signaling diagram 500 at 504 the network node 502 configures two UL PC parameter sets: SBFD_Set for SBFD slots and nonSBFD_Set for non-SBFD slots considering, e.g., time-frequency resource allocations and/or expected SI and/or CLI levels; at 506 the network node 502 sends a UL PC parameter sets configuration message to the UE 104; at 508 the UE 102 determines using the SBFD_Set a first UL power for an UL transmission to be used during SBFD slots and determine using the nonSBFD_Set a second UL power for the UL transmission to be used during non-SBFD slots; at 510 the UE 104 performs an UL transmission during SBFD slots using the first UL power; and at 512 the UE 104 performs an UL transmission during non-SBFD slots using the second UL power.

In implementations such as illustrated in the scenario 400 and the signaling diagram 500, the UE is configured (e.g., receives a configuration message) with two power control parameter sets, where the set association and/or usage is implicitly indicated. For instance, the first set (e.g., SBFD_Set 402) is implicitly indicated to be used to determine the UL power, e.g., for a PUSCH transmission during SBFD time resources. The second set (e.g., nonSBFD_Set 406) is implicitly indicated to be used to determine the UL power, e.g., for the PUSCH transmission during non-SBFD time resources.

In at least some implementations, the SBFD slots and non-SBFD slots are determined from an explicit time-frequency configuration message. In some examples, the SBFD and non-SBFD time resources are explicitly indicated within the configuration message. In at least some implementations, the DL and UL SBs within the SBFD slots are completely non-overlapped. In some implementations, the DL and UL SBs within the SBFD slots are partially or completely overlapped. In such scenarios, the SBFD-based time resources type may be categorized into several types. In some implementations, the determined UL power using the set indicated for SBFD time resources is higher than the determined UL power using the set indicated for non-SBFD time resources, such as to compensate for expected high SI and CLI levels, and therefore improving the SINR of the received UL signal.

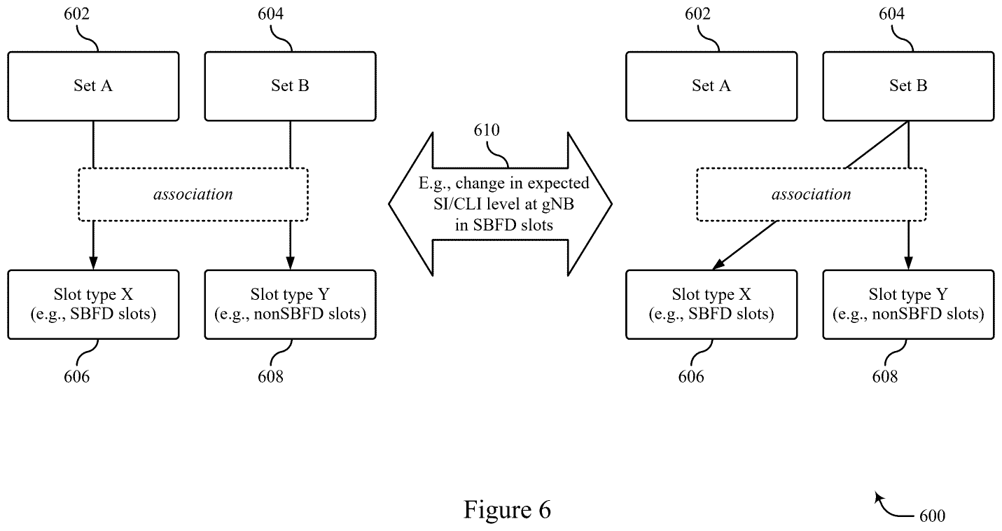

FIG. 6 illustrates an example scenario 600 in accordance with aspects of the present disclosure. The scenario 600, for instance, illustrates adaptive association between power control parameter sets and slot types, e.g., change in expected SI/CLI level in SBFD slots. The scenario 600 includes a power control parameter set 602, a power control parameter set 604, a slot type 606, a slot type 608, and SI RSs and MRs 610.

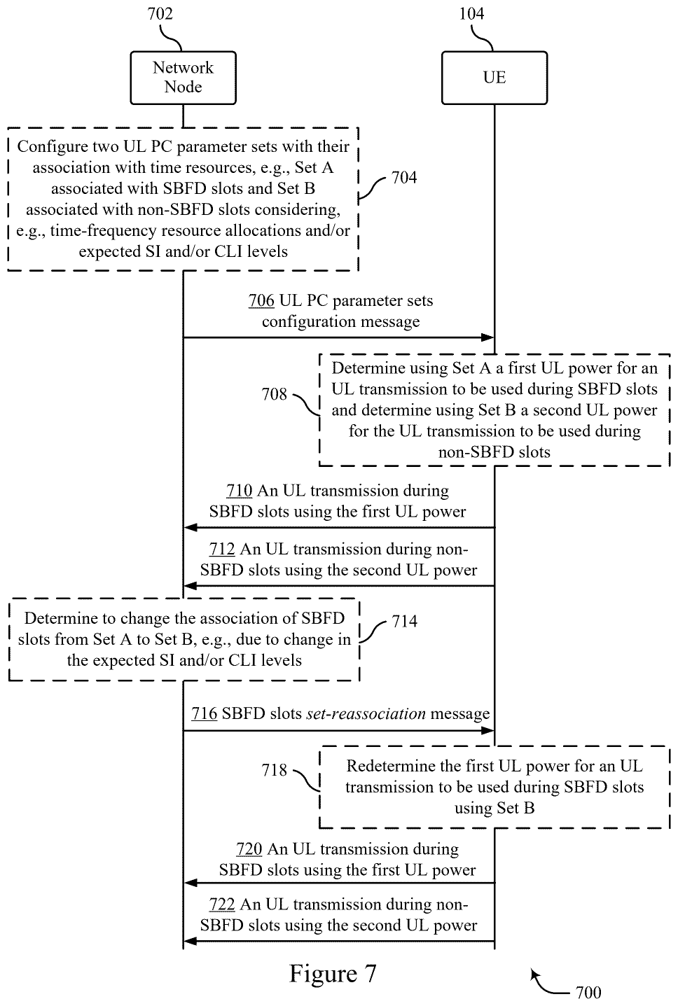

FIG. 7 illustrates an example signaling diagram 700 in accordance with aspects of the present disclosure. The signaling diagram 700 includes a network node 702 (e.g., an NE 102 such as a gNB) and a UE 104, operations of the network node 702 and the UE 104, signaling by the network node 702, and data transmission by the UE 104. In the signaling diagram 700: At 704 the network node 702 configures two UL PC parameter sets with their association with time resources, e.g., Set A associated with SBFD slots and Set B associated with non-SBFD slots considering, e.g., time-frequency resource allocations and/or expected SI and/or CLI levels; at 706 the network node 702 transmits a UL PC parameter sets configuration message to the UE 104; at 708 the UE 104 determines using Set A a first UL power for an UL transmission to be used during SBFD slots and determines using Set B a second UL power for the UL transmission to be used during non-SBFD slots; at 710 the UE 104 performs UL transmission during SBFD slots using the first UL power; at 712 the UE 104 performs an UL transmission during non-SBFD slots using the second UL power; at 714 the network node 702 determines to change the association of SBFD slots from Set A to Set B, e.g., due to change in the expected SI and/or CLI levels; at 716 the network node 702 transmits a SBFD slots set-reassociation message to the UE 104; at 718 the UE 104 redetermines the first UL power for an UL transmission to be used during SBFD slots using Set B; at 720 the UE 104 performs an UL transmission during SBFD slots using the first UL power; and at 722 the UE 104 performs an UL transmission during non-SBFD slots using the second UL power.

According to implementations a UE receives, from its serving network node (e.g., a serving gNB), a configuration message containing one or more of power control parameter sets and a set-association indicator indicating for which time resource indexes or time resource type (e.g., SBFD slots or non-SBFD slots) a set is to be used with. In at least some implementations each power control parameter set can be associated with one or more time-resource types, while each time-resource type can be associated with one power control parameter set, such as illustrated in the scenario 600. In some scenarios, the serving network may change a set association due to, e.g., change in expected SI and/or CLI levels in one or more slots or slot type.

In implementations such as illustrated in the scenario 600 and the signaling diagram 700, the UE 104 is configured with two power control parameter sets, power control parameter set 602 and power control parameter set 604, where each set is initially association with a different time resource type (e.g., SBFD or non-SBFD slots). For instance, the power control parameter set 602 is explicitly indicated to be associated during the slot type 606 (e.g., SBFD slots) and the power control parameter set 604 is explicitly indicated to be used during the slot type 608, e.g., SBFD slots. In some scenarios, the serving network may change a set-association due to, e.g., change in expected SI and/or CLI levels in one or more slots or slot type. The change in expected SI and/or CLI levels, for instance, may be due to, e.g., change of scheduled users' traffic, SI and/or CLI managing and/or handling technique, SI and/or CLI channel conditions, etc. In this case, the UE receives a set-reassociation message, e.g., via a downlink control information (DCI) or a radio resource control (RRC) message, changing the association of one or more of power control parameter sets. In some examples, the set-reassociation message indicates: the time-resource indexes (e.g., the slot indexes), and the first time-resource index and the number of time resources (e.g., x slots, starting from slot #n).

The new set association can be valid, after which the UE activities back the original/initial set association. In some implementations, the set-reassociation message indicates the first time-resource index (e.g., slot #n as the starting/first slot) without any duration or expiration indication. In another example, the set-reassociation message does not indicate time-resource indexes, and the UE assumes that the new association starts immediately, e.g., from next time resource of corresponding time resources.

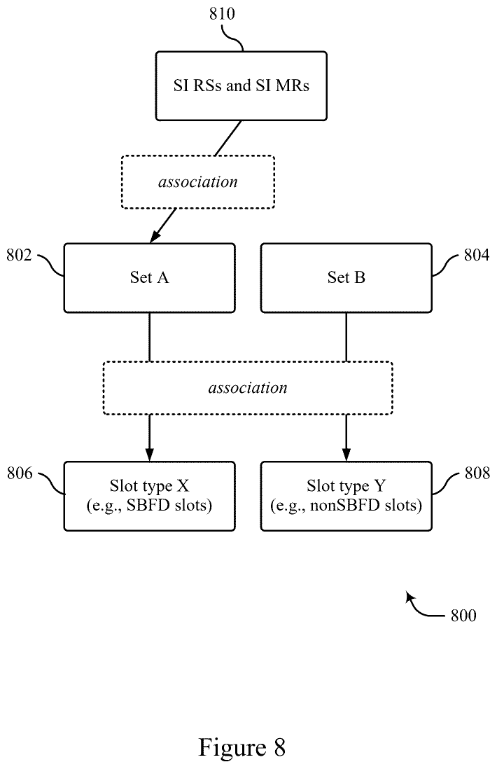

FIG. 8 and FIG. 9 illustrate example scenarios 800 and 900 in accordance with aspects of the present disclosure. The scenarios 800, 900 include a power control parameter set 802, a power control parameter set 804, a slot type 806, a slot type 808, and SI RSs and SI MRs 810. The scenarios 800, 900, for instance, illustrate adaptive and fixed association between power control parameter sets 802, 804, slot types 806, 808, and SI RSs and SI MRs 810.

In implementations a FD-capable UE receives from its serving network node (e.g., a serving gNB) a configuration message containing one or more power control parameter sets, where each power control parameter set is associated (e.g., implicitly or explicitly) with one or more time resource indexes or time resource types (e.g., SBFD or non-SBFD slots), and one or more of SI reference signals (RSs) and SI measurement resources (SI MR). In some implementations, the one or more SI RSs and/or SI MRs are associated with one or more power control parameter sets, such as illustrated in the scenario 800. In some other implementations, the one or more of SI RSs and SI MRs are associated with one or more time resource indexes or time resource types, such as illustrated in the scenario 900. The SI RSs can be implemented as a SRS or an uplink demodulation RSs (UL DMRSs).

In implementations such as illustrated in the scenarios 800, 900, the FD-capable UE is configured (e.g., receives a configuration message) with two power control parameter sets, where the set association and/or usage is implicitly indicated and/or explicitly indicated. For instance, the power control parameter set 802 is implicitly/explicitly indicated to be used to determine the UL power, e.g., for a PUSCH transmission during SBFD time resources and the power control parameter set 804 is implicitly/explicitly indicated to be used to determine the UL power, e.g., for the PUSCH transmission during non-SBFD time resources.

In implementations during a SBFD slot and as part of the open loop UL power determination (e.g., for a PUSCH transmission) a FD-capable UE uses one or more of the associated SI RSs and SI MRs 810 to compute a first UL transmit power value corresponding to a SI level below a configured, indicated, and/or predefined value. Further, an FD-capable UE uses the associated power control parameter set to determine a second UL transmit power value. The FD-capable UE can use the first and the second UL transmit power values to determine a third UL transmit power, e.g., as the minimum between the first and second transmit powers. The FD-capable UE can use the determined third UL transmit power for the PUSCH transmission during the SBFD slots.

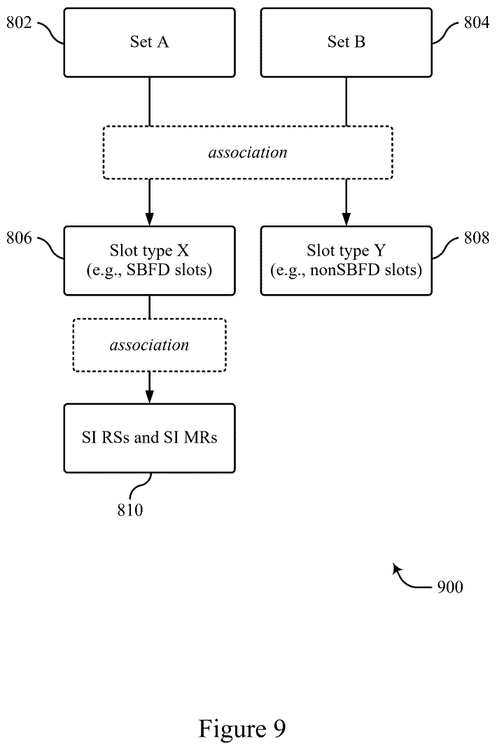

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving a configuration message for uplink power control, the configuration message indicating one or more uplink power control parameter sets each associated with a different time resource type; and transmitting, based at least in part on the configuration message and according to the one or more uplink power control parameter sets, an uplink transmission using a first uplink transmit power for the uplink transmission during a first time resource type and using a second uplink transmit power during a second time resource type.

Additionally, the UE 1000 may be configured to support any one or combination of where the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and where the configuration message implicitly associates at least one uplink power control parameter set to one or more of a time resource index set or a time-resources type; determining the first uplink transmit power based at least in part on a first uplink power control parameter set and determine the second uplink transmit power based at least in part on a second uplink power control parameter set; the one or more uplink power control parameter sets are each associated with a different time resource index set, and where the method further includes transmitting the uplink transmission according to the first uplink transmit power and the second uplink transmit power and during corresponding time resource indexes.

Additionally, the UE 1000 may be configured to support any one or combination of where the one or more uplink power control parameter sets are each associated with a different time resource index set, and where the configuration message explicitly associates an uplink power control parameter set to one or more of an indicated time resource index set or an indicated time resources type; a time-resources type includes a SBFD time resource or non-SBFD time resource; determining one or more of the SBFD time resource or the non-SBFD time resource from an independent time-frequency configuration message; receiving a set-reassociation message indicating a new associated uplink power control parameter set to be used during an indicated time resource index set or an indicated time resource type; the configuration message further includes one or more of SI RS information or SI-MRs, or a combination thereof; the one or more of the SI RS information or the SI-MRs are associated with one or more of the uplink power control parameter sets; the one or more of the SI RS information or the SI-MRs are associated with one or more time resource indexes set or one or more time resources types; the UE includes a full-duplex capable UE, and where the method further includes computing, based at least in part on the one or more of SI RS or the SI-MRs, the first uplink transmit power corresponding to a SI value below a predefined value; determining, based at least in part on an associated power control parameter, the second uplink transmit power; determining a third uplink transmit power based at least in part on the first uplink transmit power and the second uplink transmit power; transmitting the uplink transmission using the third uplink transmit power during one or more of a corresponding time resource index or a time resource type.

Additionally, or alternatively, the UE 1000 may support at least one memory (e.g., the memory 1004) and at least one processor (e.g., the processor 1002) coupled with the at least one memory and configured to cause the UE to receive a configuration message for uplink power control, the configuration message indicating one or more uplink power control parameter sets each associated with a different time resource type; and transmit, based at least in part on the configuration message and according to the one or more uplink power control parameter sets, an uplink transmission using a first uplink transmit power for the uplink transmission during a first time resource type and using a second uplink transmit power during a second time resource type.

Additionally, the UE 1000 may be configured to support any one or combination of where the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and where the configuration message implicitly associates at least one uplink power control parameter set to one or more of a time resource index set or a time-resources type; the at least one processor is configured to cause the UE to determine the first uplink transmit power based at least in part on a first uplink power control parameter set and determine the second uplink transmit power based at least in part on a second uplink power control parameter set.

Additionally, the UE 1000 may be configured to support any one or combination of where the one or more uplink power control parameter sets are each associated with a different time resource index set, and where the at least one processor is configured to cause the UE to transmit the uplink transmission according to the first uplink transmit power and the second uplink transmit power and during corresponding time resource indexes; the one or more uplink power control parameter sets are each associated with a different time resource index set, and where the configuration message explicitly associates an uplink power control parameter set to one or more of an indicated time resource index set or an indicated time resources type; a time-resources type includes a SBFD time resource or non-SBFD time resource; the at least one processor is configured to cause the UE to determine one or more of the SBFD time resource or the non-SBFD time resource from an independent time-frequency configuration message; the at least one processor is configured to cause the UE to receive a set-reassociation message indicating a new associated uplink power control parameter set to be used during an indicated time resource index set or an indicated time resource type; the configuration message further includes one or more of SI RS information or SI-MRs, or a combination thereof; the one or more of the SI RS information or the SI-MRs are associated with one or more of the uplink power control parameter sets.

Additionally, the UE 1000 may be configured to support any one or combination of where the one or more of the SI RS information or the SI-MRs are associated with one or more time resource indexes set or one or more time resources types; the UE includes a full-duplex capable UE, and where the at least one processor is configured to cause the UE to compute, based at least in part on the one or more of SI RS or the SI-MRs, the first uplink transmit power corresponding to a SI value below a predefined value; the at least one processor is configured to cause the UE to determine, based at least in part on an associated power control parameter, the second uplink transmit power; the at least one processor is configured to cause the UE to determine a third uplink transmit power based at least in part on the first uplink transmit power and the second uplink transmit power; the at least one processor is configured to cause the UE to transmit the uplink transmission using the third uplink transmit power during one or more of a corresponding time resource index or a time resource type.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

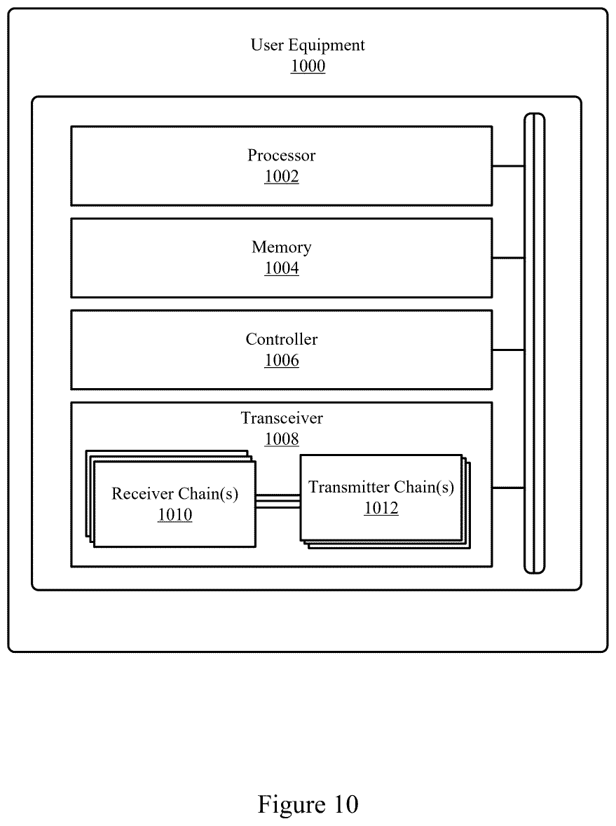

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive a configuration message for uplink power control, the configuration message indicating one or more uplink power control parameter sets each associated with a different time resource type; and transmit, based at least in part on the configuration message and according to the one or more uplink power control parameter sets, an uplink transmission using a first uplink transmit power for the uplink transmission during a first time resource type and using a second uplink transmit power during a second time resource type.

Additionally, the processor 1100 may be configured to or operable to support any one or combination of where the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and where the configuration message implicitly associates at least one uplink power control parameter set to one or more of a time resource index set or a time-resources type; the at least one controller is configured to cause the processor to determine the first uplink transmit power based at least in part on a first uplink power control parameter set and determine the second uplink transmit power based at least in part on a second uplink power control parameter set; the one or more uplink power control parameter sets are each associated with a different time resource index set, and where the at least one controller is configured to cause the processor to transmit the uplink transmission according to the first uplink transmit power and the second uplink transmit power and during corresponding time resource indexes.

Additionally, the processor 1100 may be configured to or operable to support any one or combination of where the one or more uplink power control parameter sets are each associated with a different time resource index set, and where the configuration message explicitly associates an uplink power control parameter set to one or more of an indicated time resource index set or an indicated time resources type; a time-resources type includes a SBFD time resource or non-SBFD time resource; the at least one controller is configured to cause the processor to determine one or more of the SBFD time resource or the non-SBFD time resource from an independent time-frequency configuration message; the at least one controller is configured to cause the processor to receive a set-reassociation message indicating a new associated uplink power control parameter set to be used during an indicated time resource index set or an indicated time resource type; the configuration message further includes one or more of SI RS information or SI-MRs, or a combination thereof; the one or more of the SI RS information or the SI-MRs are associated with one or more of the uplink power control parameter sets.

Additionally, the processor 1100 may be configured to or operable to support any one or combination of where the one or more of the SI RS information or the SI-MRs are associated with one or more time resource indexes set or one or more time resources types for a user equipment (UE); the configuration message is configured for a user equipment (UE), the UE includes a full-duplex capable UE, and where the at least one controller is configured to cause the processor to compute, based at least in part on the one or more of SI RS or the SI-MRs, the first uplink transmit power corresponding to a SI value below a predefined value; the at least one controller is configured to cause the processor to determine, based at least in part on an associated power control parameter, the second uplink transmit power; the at least one controller is configured to cause the processor to determine a third uplink transmit power based at least in part on the first uplink transmit power and the second uplink transmit power; the at least one controller is configured to cause the processor to transmit the uplink transmission using the third uplink transmit power during one or more of a corresponding time resource index or a time resource type.

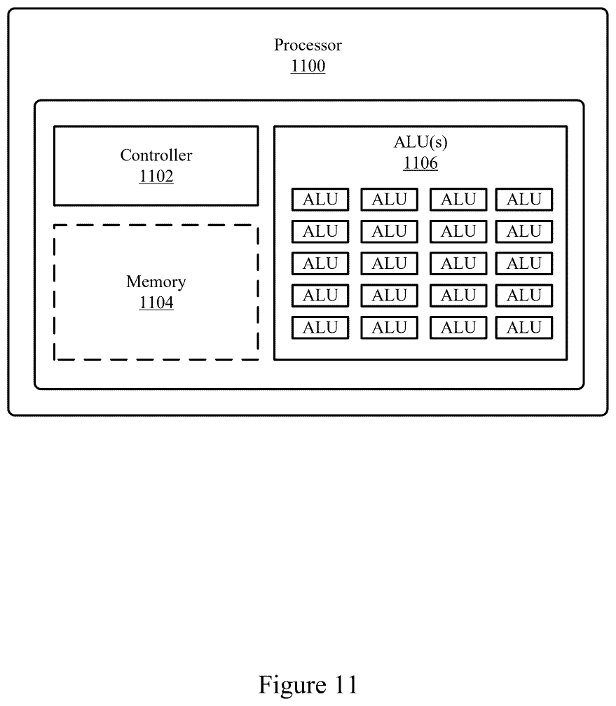

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for transmitting, to a user equipment (UE), a configuration message for uplink power control, the configuration message indicating one or more uplink power control parameter sets each associated with a different time resource type; and receiving, from the UE, an uplink transmission.

Additionally, the NE 1200 may be configured to or operable to support any one or combination of where the one or more uplink power control parameter sets are each associated with a different time resource index set; the one or more uplink power control parameter sets differ by at least one parameter value; the configuration message explicitly configures each uplink power control parameter set of the one or more uplink power control parameter sets; the configuration message explicitly configures a first uplink power control parameter set and an offset value of one or more parameters to be used for determining a second power control parameter set; the one or more uplink power control parameter sets are each associated with a different time resource index set, and where the configuration message implicitly associates at least one uplink power control parameter set to one or more of a time resource index set or a time-resources type; the one or more uplink power control parameter sets are each associated with a different time resource index set, and where the configuration message explicitly associates an uplink power control parameter set to one or more of an indicated time resource index set or an indicated time resources type.

Additionally, the NE 1200 may be configured to or operable to support any one or combination of where a time-resources type includes a SBFD time resource or non-SBFD time resource; transmitting a set-reassociation message indicating a new associated uplink power control parameter set to be used during an indicated time resource index set or an indicated time resource type; the configuration message further includes one or more of SI RS information or SI measurement resources (MRs), or a combination thereof; the one or more of the SI RS information or the SI-MRs are associated with one or more of the uplink power control parameter sets; the one or more of the SI RS information or the SI-MRs are associated with one or more time resource indexes set or one or more time resources types.

Additionally, or alternatively, the NE 1200 may support at least one memory (e.g., the memory 1204) and at least one processor (e.g., the processor 1202) coupled with the at least one memory and configured to cause the NE to transmit, to a user equipment (UE), a configuration message for uplink power control, the configuration message indicating one or more uplink power control parameter sets each associated with a different time resource type; and receive, from the UE, an uplink transmission.

Additionally, the NE 1200 may be configured to support any one or combination of where the one or more uplink power control parameter sets are each associated with a different time resource index set; where the one or more uplink power control parameter sets differ by at least one parameter value; where the configuration message explicitly configures each uplink power control parameter set of the one or more uplink power control parameter sets; where the configuration message explicitly configures a first uplink power control parameter set and an offset value of one or more parameters to be used for determining a second power control parameter set; where the one or more uplink power control parameter sets are each associated with a different time resource index set, and where the configuration message implicitly associates at least one uplink power control parameter set to one or more of a time resource index set or a time-resources type; where the one or more uplink power control parameter sets are each associated with a different time resource index set, and where the configuration message explicitly associates an uplink power control parameter set to one or more of an indicated time resource index set or an indicated time resources type.

Additionally, the NE 1200 may be configured to support any one or combination of where a time-resources type includes a SBFD time resource or non-SBFD time resource; where the at least one processor is configured to cause the network equipment to transmit a set-reassociation message indicating a new associated uplink power control parameter set to be used during an indicated time resource index set or an indicated time resource type; where the configuration message further includes one or more of SI RS information or SI measurement resources (MRs), or a combination thereof; where the one or more of the SI RS information or the SI-MRs are associated with one or more of the uplink power control parameter sets; where the one or more of the SI RS information or the S-MRs are associated with one or more time resource indexes set or one or more time resources types.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

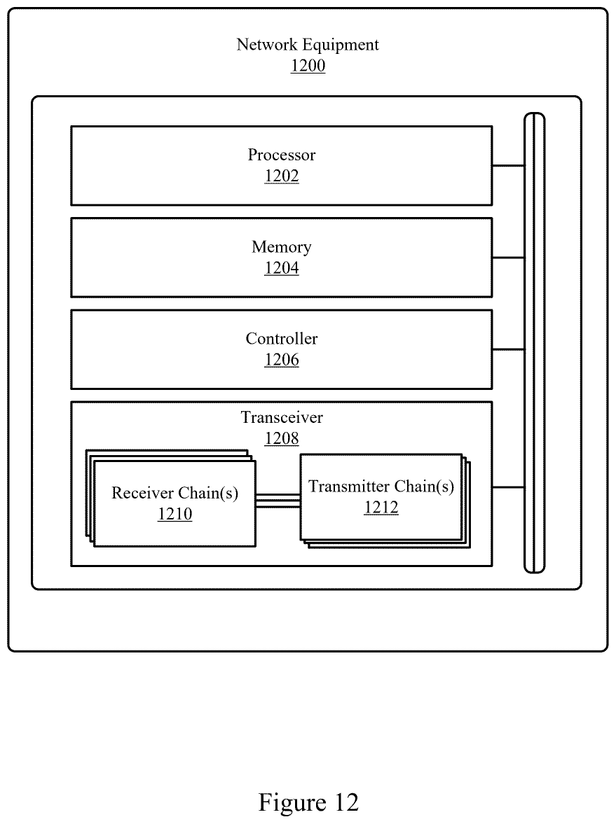

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving a configuration message for uplink power control, the configuration message indicating one or more uplink power control parameter sets each associated with a different time resource type. The operations of 1302 may be performed in accordance with examples as described herein. In some implementations, aspects of the operations of 1302 may be performed by a UE as described with reference to FIG. 10.

At 1304, the method may include transmitting, based at least in part on the configuration message and according to the one or more uplink power control parameter sets, an uplink transmission using a first uplink transmit power for the uplink transmission during a first time resource type and using a second uplink transmit power during a second time resource type. The operations of 1304 may be performed in accordance with examples as described herein. In some implementations, aspects of the operations of 1304 may be performed by a UE as described with reference to FIG. 10.

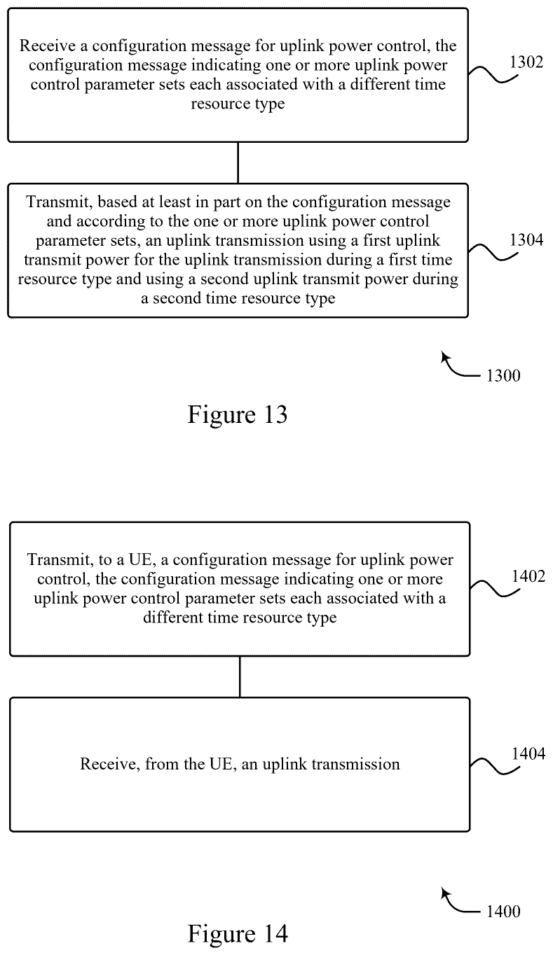

FIG. 14 illustrates a flowchart of a method 1400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting, to a UE, a configuration message for uplink power control, the configuration message indicating one or more uplink power control parameter sets each associated with a different time resource type. The operations of 1402 may be performed in accordance with examples as described herein. In some implementations, aspects of the operations of 1402 may be performed by a NE as described with reference to FIG. 12.

At 1404, the method may include receiving, from the UE, an uplink transmission. The operations of 1404 may be performed in accordance with examples as described herein. In some implementations, aspects of the operations of 1404 may be performed by a NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration message for uplink power control, the configuration message indicating one or more uplink power control parameter sets each associated with a different time resource type; and
transmit, based at least in part on the configuration message and according to the one or more uplink power control parameter sets, an uplink transmission using a first uplink transmit power for the uplink transmission during a first time resource type and using a second uplink transmit power during a second time resource type.

2. The UE of claim 1, wherein the one or more uplink power control parameter sets are each associated with a different time resource index set.

3. The UE of claim 1, wherein the one or more uplink power control parameter sets differ by at least one parameter value.

4. The UE of claim 1, wherein the configuration message explicitly configures each uplink power control parameter set of the one or more uplink power control parameter sets.

5. The UE of claim 1, wherein the configuration message explicitly configures a first uplink power control parameter set and an offset value of one or more parameters to be used for determining a second power control parameter set.

6. The UE of claim 1, wherein the one or more uplink power control parameter sets are each associated with a different time resource index set, and wherein the configuration message implicitly associates at least one uplink power control parameter set to one or more of a time resource index set or a time-resources type.

7. The UE of claim 1, wherein the at least one processor is configured to cause the UE to determine the first uplink transmit power based at least in part on a first uplink power control parameter set and determine the second uplink transmit power based at least in part on a second uplink power control parameter set.

8. The UE of claim 7, wherein the one or more uplink power control parameter sets are each associated with a different time resource index set, and wherein the at least one processor is configured to cause the UE to transmit the uplink transmission according to the first uplink transmit power and the second uplink transmit power and during corresponding time resource indexes.

9. The UE of claim 1, wherein the one or more uplink power control parameter sets are each associated with a different time resource index set, and wherein the configuration message explicitly associates an uplink power control parameter set to one or more of an indicated time resource index set or an indicated time resources type.

10. The UE of claim 9, wherein a time-resources type comprises a subband full duplex (SBFD) time resource or non-SBFD time resource.

11. The UE of claim 10, wherein the at least one processor is configured to cause the UE to determine one or more of the SBFD time resource or the non-SBFD time resource from an independent time-frequency configuration message.

12. The UE of claim 1, wherein the at least one processor is configured to cause the UE to receive a set-reassociation message indicating a new associated uplink power control parameter set to be used during an indicated time resource index set or an indicated time resource type.

13. The UE of claim 1, wherein the configuration message further comprises one or more of self-interference (SI) reference signal (RS) information or SI measurement resources (SI-MRs), or a combination thereof, and wherein one or more of;
the one or more of the SI RS information or the SI-MRs are associated with one or more of the uplink power control parameter sets; or
the one or more of the SI RS information or the SI-MRs are associated with one or more time resource indexes set or one or more time resources types.

14. The UE of claim 13, wherein the UE comprises a full-duplex capable UE, and wherein the at least one processor is configured to cause the UE to compute, based at least in part on the one or more of SI RS or the SI-MRs, the first uplink transmit power corresponding to a SI value below a predefined value.

15. The UE of claim 14, wherein the at least one processor is configured to cause the UE to determine, based at least in part on an associated power control parameter, the second uplink transmit power.

16. The UE of claim 15, wherein the at least one processor is configured to cause the UE to determine a third uplink transmit power based at least in part on the first uplink transmit power and the second uplink transmit power.

17. The UE of claim 16, wherein the at least one processor is configured to cause the UE to transmit the uplink transmission using the third uplink transmit power during one or more of a corresponding time resource index or a time resource type.

18. A processor for wireless communication, comprising:
at least one controller coupled with at least one memory and configured to cause the processor to:
receive a configuration message for uplink power control, the configuration message indicating one or more uplink power control parameter sets each associated with a different time resource type; and
transmit, based at least in part on the configuration message and according to the one or more uplink power control parameter sets, an uplink transmission using a first uplink transmit power for the uplink transmission during a first time resource type and using a second uplink transmit power during a second time resource type.

19. A network equipment for wireless communication, comprising:
at least one memory; and
at least one processor coupled with the at least one memory and configured to cause the network equipment to:
transmit, to a user equipment (UE), a configuration message for uplink power control, the configuration message indicating one or more uplink power control parameter sets each associated with a different time resource type; and
receive, from the UE, an uplink transmission.

20. A method performed by a user equipment (UE), the method comprising:
receiving a configuration message for uplink power control, the configuration message indicating one or more uplink power control parameter sets each associated with a different time resource type; and
transmitting, based at least in part on the configuration message and according to the one or more uplink power control parameter sets, an uplink transmission using a first uplink transmit power for the uplink transmission during a first time resource type and using a second uplink transmit power during a second time resource type.
